(19) United States
(12) Patent Application Publication
(10) Pub. No.: US 2024/0420253 A1
(43) Pub. Date: Dec. 19, 2024

(54) SYSTEM AND METHOD FOR IMPROVING GYM EXPERIENCE

(71) Applicant: Samantha Ball, New York, NY (US)

(72) Inventor: Samantha Ball, New York, NY (US)

(21) Appl. No.: 18/822,151

(22) Filed: Aug. 31, 2024

(51) Int. Cl. G06Q 50/00; G06V 20/50

(52) U.S. Cl. CPC G06Q 50/01; G06V 20/50

(57) ABSTRACT

The present disclosure relates generally to a localized social networking system specifically tailored for use within a weightlifting gym environment. The system facilitates real-time communication and assistance among gym users, enhances their experience and promotes the safe and effective use of gym equipment. The system enables users to request assistance with unfamiliar gym equipment from other users through a digital platform.

### FIELD OF DISCLOSURE

Systems and methods for connecting users of equipment, such as gym equipment, are provided. These systems aid in creating supportive environments for users of this equipment by connecting users needing or requesting expertise with users having expertise. Communication is typically facilitated in real-time and aids to build supportive environments using the equipment. Moreover, identification of users having expertise in these networks is streamlined through image analysis software.

### BACKGROUND

Weightlifting offers a multitude of benefits that extend beyond mere muscle building, making it an integral part of a comprehensive fitness regimen. Not only does it enhance muscular strength and endurance, but regular weightlifting improves bone density, and promotes metabolic health by increasing lean muscle mass. Westcott, W. L., “Resistance Training is Medicine: Effects of Strength Training on Health,” Current Sports Medicine Reports, 11 (4), 209-216 (2012). It also contributes to better body mechanics and posture, reduces the risk of injury in sports and other physical activities [Gabbett, T. J., et al., “Physical Fitness and Injury Risk in Sports,” Sports Medicine, 46 (6), 763-794 (2016).], and supports weight management by boosting caloric expenditure and metabolic rate [Strasser, B., & Schobersberger, W., “Evidence for Resistance Training as a Treatment Therapy in Obesity,” Journal of Obesity, Vol. 2011.] Additionally, weightlifting has significant psychological benefits, including increased self-esteem, reduced anxiety, and overall improved mental health, thereby contributing to a higher quality of life and overall well-being. [O′Connor, P. J., et al., “Effects of Resistance Training on Anxiety and Depression in Adults: A Systematic Review,” Journal of Strength and Conditioning Research, 24 (6), 2239-2256 (2010).]

Despite these well-documented benefits, there is a notable gender gap in weight training with men being over three times more likely to engage in regular weightlifting as compared to women. [“2020 Physical Activity Council's Overview Report on U.S. Participation,” Physical Activity Council, 2020.] Women often report feeling intimidated in predominately male weightlifting areas, due in part to concerns about being judged or not knowing how to use the equipment. [Brown, N. A., & White, S. R. “Gender Differences in Confidence and Knowledge of Weightlifting Equipment,” Journal of Strength and Conditioning Research, 33 (9), 2494-2501(2019).] Research from the National Center for Health Statistics indicates that 45% of women report feeling intimidated or uncomfortable in weightlifting areas of gyms, compared to only 18% of men. [National Center for Health Statistics, “Participation in Exercise and Self-Confidence: A Gender Perspective,” National Health Interview Survey, 2018.] This discomfort often leads to underutilization of weightlifting equipment and missed opportunities for strength training benefits.

There is a need for a more inclusive and empowering environment within the weightlifting area of the gym, which enables women, novice lifters, and others to request information or assistance with unfamiliar gym equipment. It is therefore an object of the present invention to provide additional utility to the gym environment by streamlining and enhancing the efficiency of information sharing of knowledge bases, providing enhanced client comfort (particularly when in the gym environment), and affording increased data collection (e.g., about gym equipment such as usage length and times, personal metrics associated with workouts including personal bests) and data transmission to users (e.g., promotional material, low usage times of specific equipment, recommended additional equipment, recommended training regimens).

### SUMMARY OF THE INVENTION

In accordance with the foregoing objectives and others, the present disclosure includes systems and methods may utility enable users to request information or assistance with unfamiliar gym equipment from other users, typically, through a digital platform. The systems of the present disclosure are often on a computer network wherein a plurality of user devices are connected to one or more servers configured to communicate with those user devices.

For example, computer systems are provided which may comprise one or more servers collectively configured to:
a) receive an image of a piece of equipment and user data from a first user device; wherein the server and/or first user device is in connection with a processer capable of analyzing the image and collecting identifying information about the equipment;
b) retrieve equipment information about the equipment based on the identifying information;
c) transmit the equipment information to a plurality of user devices; and
d) retrieve volunteer user data from a portion of the plurality of user devices including a willingness to help with the equipment.

The present application is partially premised on the efficiency increases in data transmission and networking capability associated the image analysis software and data sharing across the network. These efficiencies may be leveraged through image analysis occurring client side and/or server side. For example, in some embodiments, analyzing the image comprises accessing an artificial intelligence or machine learning algorithm. In various implementations, the computer system is characterized as having increased computational efficiency associated with matching the first user device to at least one user device in the portion of the plurality of user devices as compared to an otherwise identical system not comprising the image analysis.

Methods are also provided which may comprise:
a) receiving an image of a piece of equipment and user data from a first user device;
b) analyzing the image to identify information about the equipment;
c) transmitting the information about the equipment to a plurality of user devices; and
d) retrieving volunteer user data from a portion of the plurality of user devices including a willingness to help with the equipment.

Typically, these methods are performed over a computer network. For example, the method may comprise providing a connection system of the present disclosure. The connection system may comprise
one or more servers comprising one or more processors and configured to communicate over a communications network and interact with a plurality of user devices, each user device comprising one or more processors and a user interface operably by a user of the user device and configured to communicate over a communications network and interact with the one or more servers,
one or more databases accessible by the one or more servers comprising a plurality of user profiles representing users, a plurality of matches representing matched pairs of users, and a plurality of connections representing connected pairs of users. The user profiles and database typically includes information about equipment a user has used (e.g., the user has uploaded a photo of the equipment, the user has indicated they are willing to help users with the specific equipment).

### BRIEF DESCRIPTION OF THE DRAWING

FIG. 1 provides the process flow for an exemplary method of the present disclosure which may be used by one or more servers as described herein.

### DETAILED DESCRIPTION

Detailed embodiments of the present disclosure are disclosed herein; however, it is to be understood that the disclosed embodiments are merely illustrative of the disclosure that may be embodied in various forms. In addition, each of the examples given in connection with the various embodiments of the disclosure is intended to be illustrative, and not restrictive.

All terms used herein are intended to have their ordinary meaning in the art unless otherwise provided. All concentrations are in terms of percentage by weight of the specified component relative to the entire weight of the topical composition, unless otherwise defined.

As used herein, “a” or “an” shall mean one or more. As used herein when used in conjunction with the word “comprising,” the words “a” or “an” mean one or more than one. As used herein “another” means at least a second or more.

The present disclosure includes systems configured to send and transmit information between one another (e.g., the one or more servers, one or more user devices such as web enabled mobile devices including smartphone devices). These systems may comprise one or more servers collectively configured to:
a) receive an image of a piece of equipment and user data from a first user device; wherein the server and/or first user device is in connection with a processer capable of analyzing the image and collecting identifying information about the equipment;
b) retrieve equipment information about the equipment based on the identifying information;
c) transmit the equipment information to a plurality of user devices; and
d) retrieve volunteer user data from a portion of the plurality of user devices including a willingness to help with the equipment.

In some embodiments, the user devices (e.g., first user device, a subset of the plurality of user devices, the plurality of user devices) are a web-enabled mobile device (which typically comprises a camera). A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), and the like, to display and send a message.

Mobile devices also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to the one or more servers, client devices, or other computing devices.

Mobile devices may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device. However, the present invention is not limited to these message protocols, and virtually any other message protocol may be employed.

Mobile devices may be further configured to enable a user to participate in communications sessions, such as IM sessions. As such, mobile devices may include a client application that is configured to manage various actions on behalf of the client device. For example, the client application may enable a user to interact with the browser application, email application, IM applications, SMS application, and the like.

Mobile devices may further be configured to include a client application that enables the end-user to log into an end-user account that may be managed by another computing device, such as the one or more servers. Such end-user account, for example, may be configured to enable the end-user to receive emails, send/receive IM messages, SMS messages, access selected web pages, participate in a social networking activity, or the like. However, participation in various social networking activities may also be performed without logging into the end-user account.

In addition, mobile devices may include another application that is configured to enable the mobile user to display and interact with various integrated live views that are configured based, in part, on the mobile user's social networking activities, experiences, and the like, including vitality information associated with the mobile user's social network. The integrated live views may be directed towards providing the mobile user with a virtual ‘hang-out’ space for participating in various social events, including but not limited to sending/receiving photos between social networking members, ‘chit-chatting’ with members, blogging, sharing visual mood representations, sharing various messages, and generally participating in a variety of integrated social experiences beyond merely voice communications or text messages (e.g., IM). Moreover, such integrated live views enable the mobile user to configure highly personalized views and identities in virtual spaces within their social network.

Mobile devices may also communicate with non-mobile client devices, such as client device, or the like. In one embodiment, such communications may include participation in social networking activities, including sharing of photographs, participating in determining how to spend time with other members, sending/receiving of messages, providing information based on physical proximity between members, or similar virtual hang-out activities.

The client device may include virtually any computing device capable of communicating over a network to send and receive information, including social networking information, or the like. The set of such devices may include devices that typically connect using a wired or wireless communications medium such as personal computers, multiprocessor systems, microprocessor-based or programmable consumer electronics, network PCs, or the like.

Typically, the wireless network is configured to couple mobile devices and its components affording transmission of data therebetween. The wireless network may include any of a variety of wireless sub-networks that may further overlay stand-alone ad-hoc networks, and the like, to provide an infrastructure-oriented connection for mobile devices. Such sub-networks may include mesh networks, Wireless LAN (WLAN) networks, cellular networks, and the like.

System may comprise a network configured to couple the one or more servers and their components with other computing devices, including, mobile devices, and client devices, and through wireless networks to mobile devices. The network is enabled to employ any form of computer readable media for communicating information from one electronic device to another. Also, the network can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3,and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link.

These systems may communicate, in part, over a wireless network. The wireless network may further include an autonomous system of terminals, gateways, routers, and the like connected by wireless radio links, and the like. These connectors may be configured to move freely and randomly and organize themselves arbitrarily, such that the topology of the wireless network may change rapidly.

The wireless network may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide arca coverage for mobile devices, such as mobile devices with various degrees of mobility. For example, the wireless network may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices and another computing device, network, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

In various embodiments, the one or more servers may be further configured to:
c1) transmit a portion of the volunteer user data to the first user device, and/or
c2) transmit the user data to a portion of the plurality of user devices indicating a willingness to help with the equipment.

The servers may be configured to help connect user of the first user device to those users willing to help with the equipment. For example, contact information between each party may be shared, such as location data, telephone numbers, or email addresses. In some embodiments, the one or more servers are configured to receive a rating regarding the volunteer user in the portion of plurality of user devices. In particular embodiments, the equipment is gym equipment. The one or more servers may be further configured to receive information regarding the usage of the equipment (e.g., from the equipment as connected to a network) during the time period the first user device and/or a member of the portion of the plurality of user devices is proximal (e.g., within 5 feet) of the equipment. In certain aspects, the one or more servers are further configured to transmit operational parameters for the equipment to the equipment during the time period the first user device and/or a member of the portion of the plurality of user devices is proximal (e.g., within 5 feet) of the equipment.

An online social network, such as those described herein which may be formed using the systems and methods of the present disclosure, typically comprises a person's set of direct and/or indirect personal relationships, including real and virtual privileges and permissions that users may associate with these people. Direct personal relationships usually include relationships with people the user can communicated with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship.

As used herein, “live” or a “live view” refers to providing of real-time or approximately real-time data. It is recognized that due to a variety of reasons, transfer of data over a network may be delayed by some varying amount of time. The delay may vary based on conditions of the network, configurations of the network, configuration of the sending and/or receiving device, or the like. Thus, live or a live view may range between real-time data transfers to some varying amount of time delay.

The term “vitality” as used herein refers to online and/or offline activities of a member of a social network. Thus, vitality information is typically directed towards capturing these aspects of a social community, through various communications between members, and their activities, states, and/or moods of various members, or the like. Vitality information may include, but is not limited to a location of the mobile device, weather information where the member is located, an event, information from the mobile user's calendar or even a friend's calendar, information from the mobile user's task list, past behavior of the mobile user and/or another member of the social network, the mobile user's preferences, a mood of a social network member, a mood of the mobile user, photographs, video files, audio files, internet links, information from a blog, an Really Simple Syndication (RSS) feed, Instant Messages (IMs), blog entries, emails, or the like, and even information about physical (e.g., geographical) proximity of the mobile user's social contacts, what the mobile user is doing at the moment in the real world, or the like. Within the specific social networks described in the present application vitality information typically includes areas of expertise, particularly within the conduct of equipment and training knowledge. Vitality information however, is not limited to these examples, and other information that may describe the lively, open, or animated aspects of a social network may also be employed.

Moreover, the term “social networking information,” includes vitality information. However, social networking information refers to both dynamic as well as less dynamic characteristics of a social network. Social networking information includes various profile information about a member, including, but not limited to the member's avatar, contact information, the member's preferences, degrees of separation between the member and another member, a membership in an activity, group, or the like, or the like.

Social networking information further may include various information about communications between the member and other members in the social network, including, but not limited to emails, SMS messages, IM messages, Multimedia Message (MMS) messages, alerts, audio messages, phone calls, either received or sent by the member, or the like.

Various “meta-data” may also be associated with the social networking information. Thus, for example, various permissions for access may be associated with at least some of the social networking information. Some access permissions (or sharing rules) may be selected, for example, based, in part, on an input by the member, while other access permissions may be defaulted based on other events, constraints, or the like.

Briefly stated the present invention is directed towards enabling integrated live views of activities of a mobile user's contacts to provide the mobile user with information about users available to help specific equipment in a social networking context. The integrated live views may be provided by employing social networking vitality information to generate a live contact list. Such vitality information includes those users identified as having expertise regarding any specific equipment. Integrated live views may also be provided in a variety of other perspectives, including, but not limited to integrated live: group views, friend views, activity-oriented views, or the like, based on the mobile user's social networking information, including vitality information. Use of social networking information provides a more dynamic and potentially changing view of the mobile user's relationships with other members of their social network, unlike traditional views that may lack this dynamic and more personal perspective. Moreover, traditional views on a mobile device may limit how the mobile user may organize received information. That is, traditional views may provide contact information, but it typically is not integrated with IM status, mood status, email status, or the like. Similarly, traditional views may provide IM status, but it typically is not integrated with calendar information, location information, or the like. Thus, live views enable an integrated, and more personalized perspective of a mobile user's social and other communication activities.

Moreover, by providing the mobile user with integrated live views of their social network, the invention enables the mobile user to manage their time more effectively with the equipment. By viewing one's live contact lists, or other integrated live views, the mobile user may be able to communicate with other members of their social network very quickly upon deciding to work with any equipment.

In some implementations, when enrolling in a connection system of the present disclosure, a user may access a user account management module to create a user account and establish login credentials which may then be used for ongoing secure access to their user account. In some implementations, user account management module may be configured to additionally or alternatively be responsive to a third-party authentication service for secure user login (e.g., such as equipment manufacturers which may sponsor users), wherein a user may establish login capability by logging in through a third party service such as logging in through a Google account, a Facebook account or other third party service providing such authentication services. In some implementations, use of such third party authentication services may provide access to certain data and information associated with a user and comprised by the third party service, such as for example, possible access to a user's one or more email addresses, the user's birthday, the user's gender, user photos, user videos, user social contacts and other data and information associated with the user which, when accessed by the connection system, may reduce the amount of data and information requiring entry by the user when creating or updating a user account. Additionally, the user may avoid the need to create and remember an additional set of login credentials required for logging into connection service. In some implementations the login process may include an additional, one or more, authentication steps, such as in two-factor authentication or multi-factor authentication, wherein an additional one or more authentication steps beyond a submitting of a username and password are required to complete the account login process. Such additional authentication steps could comprise the sending of a single or limited use code via one or more communication methods comprising emailing, text messaging, such as an SMS messaging, and voice messaging wherein the single or limited use code must be entered as an additional step in the login process. Such additional authentication steps could alternatively, or additionally, comprise biometric measures such as a fingerprint reading or facial image reading of a user, wherein the reading is accomplished in conjunction with a user device, and the result of the reading may then be compared with a prior reading stored within data services to authenticate an entity attempting to login and thereby make a determination whether to grant login and access to a user account comprised by system.

The user account management module may further manage user interaction with user profiles management module wherein a new user may create a user profile associated with their user account and an existing user may edit a previously created and stored user profile comprised by data service. A user profile may comprise images of the user and other information related to the user, such as the user's age, primary location, general location, current location, and vitality information (e.g., information relating to specific equipment usage), ratings associated with training of the equipment. In some implementations, user profiles may comprise numerous details about users, and in some implementations, user profiles may be limited in the amount of details. In some implementations, user profiles may be created or updated, at least in part, by connection system accessing user information comprised by a third-party system, such as social networking system or information from equipment manufacturers, wherein such access is available with the associated user's provision of necessary permissions for such access. In some implementations, the third-party system may be provisioned as a third party authentication service for user login to the connection system, wherein the third party authentication service provides such access to usable information related to the user. In such implementations where system accesses third party information to at least in part create or update user profiles, the user may review, edit and complete information as necessary in addition to connection system populating user profile information retrieved from third party systems.

Users may receive candidate matches comprising the user profiles of other users, or portions thereof, which are of potential interest and make determinations of their further interest, or lack thereof, in the users associated with each of the received candidate matches. A user associated with a received candidate match may be referred to as a candidate match user. A user receiving a candidate match may be referred to as a receiving user. The user account management module may receive from a user a user request to receive candidate matches of other users represented by their user profiles, or portions thereof, within a connection system. In order to receive candidate matches of potential interest, users may specify filtering, selecting and matching criteria (in addition to filters provided by the image of equipment), such as for example, age, range of age, gender, location, range of proximity to a location, online status and equipment training rating (e.g., as collected from other users in the connection system), wherein such criteria may be called match settings and be used to filter a pool of match candidates from the overall population of user profiles comprised by databases and the connection system. In some implementations, the user account management module manages interaction with candidate matching and selection module such that a user may specify such match settings, where the match settings may be associated with their user account and/or user profile and stored for later retrieval in data services for use when a user submits a request for candidate matches to select a pool of candidate matches meeting, at least in part, match settings specified by the user. In some implementations, a user may specify match setting in conjunction with a request for candidate matches. The user may then consider user profiles from the pool of candidate matches and provide a positive match interest indication or a negative match interest indication regarding their interest in each of the candidate matches they consider, thereby providing a positive interest indication for those candidate matches within the pool of received candidate matches with which they have interest in exploring a connection. In some implementations, during the process of specifying match settings, the user may be presented with an indication of the size of the pool of candidate matches that are at least in part associated with the match settings. Such an indication may be indicated in exact or approximate numbers or ranges of numbers, or be expressed in general terms indicating an issue of too many to practically be reviewed and considered, or too few match candidates indicating little to none to review and consider, with guidance to increase or reduce the specificity of match settings (filter criteria) to accordingly attempt to correct the issue.

In some implementations, the pool of match candidates may be prioritized for presentation to the user in an order representing, at least in part, a degree of correlation between the candidate match profiles and the user match settings. In some implementations, the order of presentation to the user may be an order in which the candidate matches were retrieved. In some implementations other criteria may be used to order the candidate matches for presentation, such as, recent match activity associated with the candidate match, recent match activity of the requesting user with candidate matches of similar or specific criteria correlation, candidate match length of time in the connection system, candidate match length of time since last match or qualified connection, etc. Two users of connection system may request, consider and provide match interest indications in candidate matches, such that they each receive the other user's user profile, and indicate a positive match interest in the other user, thereby resulting in mutual positive match interest indications, wherein the latter occurring of the two may be referred to as a reciprocal positive match interest indication. Upon a reciprocal positive match interest indication, a match is typically created between the two users having indicated mutual positive match interest indications in each other and thereby expressing interest in exploring a connection therebetween and allowing for communication between the two users (e.g., via phone call, text message, video chat).

In some implementations, after a match is created, the next interaction between the two users of the match may be through a video chat, or in regards thereto, such as the initiation or scheduling of a video chat (e.g., the video chat may be the requested training). As such, in some implementations a limited communication between the two users regarding the initiation or scheduling of a video chat may be facilitated. The user account management module may manage user interaction with match and connection management, which may comprise a user communication controller, and may collectively facilitate a communication between a pair of users having expressed mutual positive match interest indications and thereby creating a match therebetween. In some implementations, there may be a requirement to video chat within a chat time window, wherein a time window may commence at a time in relation to the creation of a match, such as the time a match is created. In some implementations, if a video chat time window requirement is not met, then the match may expire or may be otherwise inactivated upon the expiration of the chat time window. In some implementations, a facilitation of communication may include a plurality of facilitating functions which may be provided by the match and connection management module and in part by a user communication controller, such as, notifications and review capabilities by users of their matches, management of match expirations with respect to their respective chat time windows, scheduling and review capabilities by users of their scheduled video chats, hosting of, or controlling a host of, the video chats and determinations of success or failure of meeting qualification requirements of video chats.

In some embodiments, communication regarding scheduling of communication (e.g., phone calls, video chats, in person meetings) may be restricted by the match and connection management module and in part by the user communication controller, to preset phrases and calendar/day/time selections in order to limit and control what may be communicated between matched users. In some implementations upon a reciprocal positive match interest indication resulting in a match, a prompt may be displayed on a user device to immediately attempt a qualifying video chat and/or to attempt to schedule a qualifying video chat and be displayed in conjunction with the notice that the match has been created. In some implementations a match notification may be additionally sent to the other user of the pair of matched users informing the other user that the match has been created and may additionally prompt the other user to immediately attempt a qualifying video chat and/or to attempt to schedule communication (e.g., phone call, text message, video chat, in person meeting). In some implementations users may check to see all pending matches within their account, review if and when a qualifying video chat is scheduled and determine if any matches are at risk of expiration due to an expiring chat time window. For example, a list of one or more matches which may be pending may be displayed in a scrollable list on a user device, each match including, for example, a “head shot” image and a user name, both as may be associated with a user profile of the matched user, an indicator of time remaining prior to an expiration of a connection time window associated with the match, and an indication of a scheduling status regarding a qualifying video chat associated with the match.

In some implementations, one or more matches may be shown with an indication of current availability status of the matched user, such as for example, a green indicator bordering an image of the matched user to indicate the matched user may be presently available for communication (e.g., video chat, phone call, in person meeting) a yellow border to indicate the matched user may be presently busy or no border to indicate an unknown availability status. In some embodiments, the indication of current availability may indicate the type of communication a user is able to accept at that time (e.g., video chat, phone call, in person meeting). In some implementations, a user may indicate their current availability through a setting within their account comprised by system which may then be shown to other users with which they are currently matched (or were identified in a search). In some implementations a limit on the number of new matches which may be acquired over a period of time, day, number of days or the like, may be imposed. In some implementations a limit of currently active matches, wherein active match means not yet expired or converted to a qualified connection, may be imposed.

The match and connection management module and user communication controller may facilitate controlled communication and the associated qualification process. In some implementations, facilitation of controlled communication may include additional functions, such as video chat rescheduling, video chat reattempts, video chat time window extension requests, upcoming scheduled video chat alerts, and tests and warnings for poor communications connections associated with an impending or recently initiated video chat. As such, in some implementations users may attempt to reschedule a pending communication. Furthermore, the match and connection management and the user communication controller may facilitate a video chat between two users comprising a match by providing alerts and reminders to users when scheduled video chats are imminent. Additionally, in some implementations the wireless connection signal strength and quality may be assessed in advance of the video chat to determine if it is sufficient to provide an effective video chat of sufficient anticipated quality. If not, the user may then take action to improve the connection prior to the video chat, such as, move to a location with better reception or switch from a WAN to a wireless LAN connection or vice versa, or attempt to reschedule the network-based communication until a better connection may be available. In some implementations, upon completion of an initial communication, one or each of the two users may provide a second interest indication (the first interest indication being a match interest indication) regarding the other user, wherein the second interest indication may be a positive connection interest indication or a negative connection interest indication regarding their interest in ongoing communication with the other user. If there is mutual positive interest thereby resulting in mutual positive connection interest indications, wherein the latter occurring of the two may be referred to as a reciprocal positive connection interest indication, a connection may be created between the two users and further communication may be enabled wherein the match and connection management module and the user communication controller, may enable the two connected users to communicate with each other in an ongoing fashion.

The user account management module may manage user interaction with a user services and policies module and thereby may allow users of a connection system to request and/or access user assistance and other support services, such as to ask questions regarding system functionality and services, and to access and report policy rules and concerns. In some embodiments, the user services and policies module may also allow users to report policy infractions and other concerning behavior of other users such that a user based policing procedure may be supported. For example, in some implementations, users may be automatically blocked from use upon a given number, such as three, reports being submitted regarding their policy infractions or concerning behavior. A blocked user may then have to successfully appeal to be reinstated to use of the system.

A data services module may provide data storage and access thereto (the module typically being used to assign which data for transmission to the users from the server) for data in one or more databases, such as for example, user account data, user profile data, user interest indication data, match data, video chat data, scheduling data, time window data, connection data, user policy data, user services data and the like.

User mobile devices containing the requisite components and instructions to operate on the social media network are also provided. An exemplary user mobile device is a smartphone which typically comprises a camera and an ability to upload images taken therefrom to the one or more servers. The smartphone device may comprise an application services mobile app interface, application logic and workflow, platform services and devices and a user interface. Application logic and workflow may provide for management and control of user interaction with a user's smartphone device and a user's user account comprised by connection system via applications services mobile app interface which may be connected to application services systems interface of application services system over the network and communication links. The application logic and workflow module may control the user interface to display information, such as for example, a user account status, a menu of available user operations (e.g., take an image of an equipment, identify equipment from image, upload image), candidate matches, matches, pending video chats, communications and the like. The application logic and workflow module may receive user input from the user interface, such as for example, a user selection from a menu of available user operations, a user match interest indication regarding a candidate match, a user request for a video chat with a match, a user connection interest indication regarding a match after a qualified video chat therewith and the like. The application logic and workflow module may access platform services and devices to interact with a plurality of platform services and devices of the smartphone device, such as, cameras, audio speakers/headphones, geo location services, sensors, computing resources, data storage and access resources, device communications, user text communications, user voice communications, user video communications, any connected Bluetooth devices such as a fitness monitor connected to one or more sensors that measure aspects of subject (e.g., step rate, sweat rate, heart rate, pulse oximetry) and the like.

The mobile phone device may comprise a bus which includes a component that permits communication among the components of device such as the processer. The processor may be implemented in hardware, firmware, or a combination of hardware and firmware. Processor systems may include one or more of a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, the processor includes one or more processors capable of being programmed to perform a function. The processor may be in communication with memory which may be random access memory (RAM), a read only memory (ROM), and/or another type of dynamic or static storage device (e.g., a flash memory, a magnetic memory, and/or an optical memory) that stores information and/or instructions for use by processor.

The smartphone device may be configured with a communication interface which can include a transceiver-like component (e.g., a transceiver and/or a separate receiver and transmitter) which may enable the device to communicate with other devices, such as via a wired connection, a wireless connection, or a combination of wired and wireless connections. The communication interface may permit the device to receive information from another device and/or provide information to another device (e.g., the one or more servers). For example, communication interface may include an Ethernet interface, an optical interface, a coaxial interface, an infrared interface, a radio frequency (RF) interface, a universal serial bus (USB) interface, a Wi-Fi interface, a cellular network interface, or the like.

A plurality of hardware and software-based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. In at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

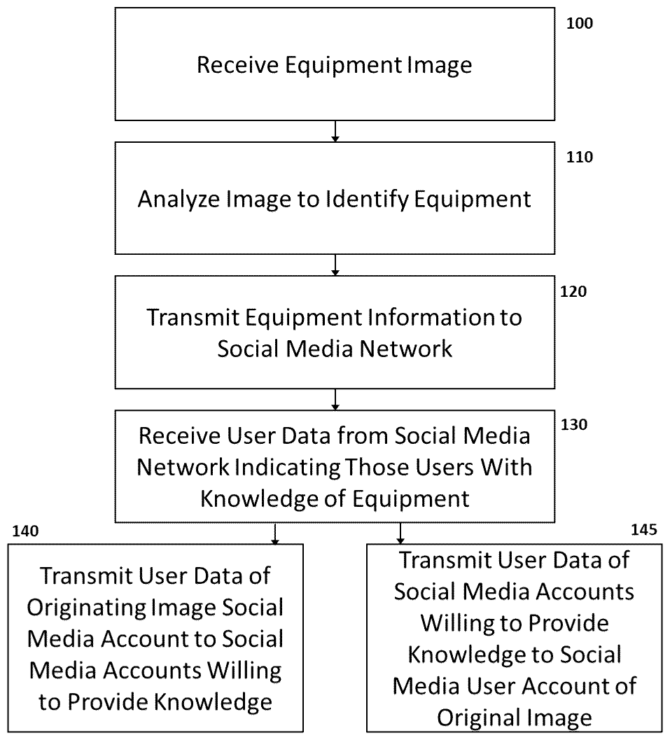

Referring now to FIG. 1, an exemplary method (which may be implemented over a computer system and/or social network) of the present disclosure is provided. For example, FIG. 1 details the actions of the one or more servers for users. After users have created a user profile in the social media network, they may take one or more images (e.g., with a smartphone) and transmit them to the server. The server receives the images at step 100 and proceed to analyze the image in order to identify the equipment (e.g., by category, type, manufacturer) at step 110. In some embodiments, the image analysis occurs on the user device (e.g., the smartphone contains the image analysis software and equipment information (e.g., category of equipment, type of equipment, model of equipment, manufacturer of equipment, serial number of equipment, specific settings of equipment (e.g., as collected from other members in the social media network) is sent to the one or more servers). This equipment information and request for assistance is transmitted to users of the social media network at step 120 where users are able to view the request for assistance and some or all of the equipment information. In some embodiments, the image is transmitted to the social media network. In some embodiments, data of the first user (e.g., name, avatar, location) or a portion thereof, may be transmitted to the social media network as well. In various implementations, the equipment information and request is transmitted only to those users who have set a preference for working with the equipment identified (e.g., users have set filter criteria indicating a willingness to work with the identified equipment optionally with one or more other parameters such as requesting user location). Users willing to offer help or advice then transmit their willingness to help to the one or more servers at step 130. User data of the first user requesting assistance may then be transmitted to the plurality of users willing to offer help at step 140. Additionally, the user data from the plurality of users willing to offer help may also be transmitted to the first user at step 145. This plurality of users may be filtered based on the first user's criteria (e.g., age, gender, level of expertise, rating). In various implementations, the system may then facilitate communication between the first user requesting assistance and one or more of the plurality of users willing to offer assistance. In various implementations, step 140 is absent and only the first user is able to facilitate initial communication with the plurality of users identified as being willing to offer assistance.

The image analysis may begin by assessing whether whether image data is within a predetermined range that the image analysis software is configured to analyze. For example, a server and/or user device of the system may comprise memory including computer executable instructions (or software) for determining, among other things, whether image data is within a predetermined range that the image analysis software is trained to analyze. For example, the image may need to be taken from a range of distances and with an appropriate view of the equipment to identify its category of equipment (e.g., treadmill, exercise bike, elliptical, rowing machine, dumbbell, leg press, cable machine, let extension, smith machine, power rack, stairclimber, barbell, pull-down, dip bar, weight bench, chest press, cross trainer, strength machine). The image analysis software may include a convolutional neural network (CNN) (or, more broadly machine learning software) and functionality software. In various implementations, the CNN is trained to make predictions related to detecting and classifying objects, such as specific components of the equipment such as weight location, positions for the user to operate the equipment in relation thereto, and any identifying characteristics of the equipment such as labels, serial numbers, and model numbers. While the image analysis software is described herein as including a CNN it should be noted that the image analysis software may include a different type of machine learning software, for example, a decision tree or a Bayesian network.

The functionality software may rely on predictions made by the image analysis software (for example, the CNN) of the equipment, coupled with information about the user to provide functionality and training advice to the vehicle user and/or those users identified as willing to help the user. In some embodiments, the functionality software automatically transmits the information to the equipment (if, for example, the equipment is connected to the network) such that specific settings may be applied to the equipment (e.g., weight amount, length of training, cardiovascular routines associated with that and other recommended equipment).

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible considering the above teachings. Accordingly, the present description is intended to embrace all such alternatives, modifications and variances which fall within the scope of the appended claims.

All documents cited or referenced herein, and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

What is claimed is:

1. A computer system comprising one or more servers collectively configured to:
a) receive an image of a piece of equipment and user data from a first user device;
wherein the server is connection with a processer capable of analyzing the image and collecting identifying information about the equipment;
b) retrieve equipment information about the equipment based on the identifying information;
c) transmit the equipment information to a plurality of user devices; and
d) retrieve volunteer user data from a portion of the plurality of user devices including a willingness to help with the equipment.

2. The computer system according to claim 1, wherein the one or more servers are further configured to:
e1) transmit a portion of the volunteer user data to the first user device, and/or
e2) transmit the user data to a portion of the plurality of user devices indicating a willingness to help with the equipment.

3. The computer system according to claim 1, wherein the one or more servers are further configured to receive a rating regarding individual user devices in the portion of plurality of user devices.

4. The computer system according to claim 1, wherein the equipment is gym equipment.

5. The computer system according to claim 1, wherein the one or more servers are further configured to receive information regarding the usage of the equipment (e.g., from the equipment as connected to a network) during the time period the first user device and/or a member of the portion of the plurality of user devices is proximal (e.g., within 5 feet) of the equipment.

6. The computer system according to claim 1, wherein the one or more servers are further configured to transmit operational parameters for the equipment to the equipment during the time period the first user device and/or a member of the portion of the plurality of user devices is proximal (e.g., within 5 feet) of the equipment.

7. The computer system according to claim 1, wherein analyzing the image comprises accessing an artificial intelligence or machine learning algorithm.

8. The computer system according to claim 1, wherein the computer system is characterized as having increased computational efficiency associated with matching the first user device to at least one user device in the portion of the plurality of user devices as compared to an otherwise identical system not comprising the image analysis.

9. A method comprising:
a) receiving an image of a piece of equipment and user data from a first user device;
b) analyzing the image to identify information about the equipment;
c) transmitting the information about the equipment to a plurality of user devices; and
d) retrieving volunteer user data from a portion of the plurality of user devices including a willingness to help with the equipment.

10. The method according to claim 9, further comprising
e1) transmitting a portion of the volunteer user data to the first user device, and/or
e2) transmitting the user data to a portion of the plurality of user devices indicating a willingness to help with the equipment.

11. The method according to claim 9, wherein the one or more servers are further configured to receive a rating regarding individual user devices in the portion of plurality of user devices.

12. The method according to claim 9, wherein the equipment is gym equipment.

13. The method according to claim 9, further comprising receiving information regarding the usage of the equipment (e.g., from the equipment as connected to a network) during the time period the first user device and/or a member of the portion of the plurality of user devices is proximal (e.g., within 5 feet) of the equipment.

14. The method according to claim 9, further comprising to transmission of operational parameters for the equipment to the equipment during the time period the first user device and/or a member of the portion of the plurality of user devices is proximal (e.g., within 5 feet) of the equipment.

15. The method according to claim 9, wherein analyzing the image comprises accessing an artificial intelligence or machine learning algorithm.

16. The method according to claim 9, wherein the method is characterized as having increased computational efficiency associated with matching the first user device to at least one user device in the portion of the plurality of user devices as compared to an otherwise identical system not comprising the image analysis.
